(19) United States
(12) Patent Application Publication
(10) Pub. No.: US 2006/0062398 A1
(43) Pub. Date: Mar. 23, 2006

(54) Speaker distance measurement using downsampled adaptive filter

(76) Inventors: Joel C. McKee Cooper, Lafayette, CO (US); John L. Melanson, Austin, TX (US); Gert E. Rosenboom, Longmont, CO (US)

Correspondence Address: Robert Platt Bell, 8033 Washington Road, Alexandria, VA, 22308, US

(21) Appl. No.: 11/038,577

(22) Filed: Jan. 21, 2005

Related U.S. Application Data
(63) Continuation-in-part of application No. 11/002,102, filed on Dec. 3, 2004.
(60) Provisional application No. 60/612,474, filed on Sep. 23, 2004.

(51) Int. Cl. H04R 29/00; G01C 25/00; G06F 19/00

(52) U.S. Cl. 381/58; 381/59; 702/97

(57) ABSTRACT

A downsampled adaptive filter is used to find the impulse response of a home theater system. Downsampling yields higher maximum measurable distance for given filter length. By using a Least-Mean-Square (LMS) adaptive filter, almost anything can be used as the source noise. While downsampling may decrease the resolution of the distance measurement, Adaptive Filtering allows a much broader range of test signals, as opposed to MLS (Maximum Length Sequence) in which the test signal defines the technique (a pseudo-random Maximum Length Sequence.)

### CROSS-REFERENCE TO RELATED APPLICATIONS

The present application claims priority from Provisional U.S. Patent Application No. 60/612,474 filed on Sep. 23, 2004 (Cirrus Logic Docket No. 1537-DSP), and incorporated herein by reference. The present application is also a Continuation-In-Part of U.S. patent application Ser. No. 11/002,102 entitled “TECHNIQUE FOR SUBWOOFER DISTANCE MEASUREMENT”, filed on Dec. 3, 2004 (Cirrus Logic Docket No. 1538-DSP), and incorporated herein by reference.

### FIELD OF THE INVENTION

The present invention relates to a method and apparatus for calibrating a home theater system. In particular, the present invention is directed toward a technique for measuring the distance between a speaker and a listener location using a downsampled adaptive filter.

### BACKGROUND OF THE INVENTION

Home theater systems, which once were expensive luxury items, are now becoming commonplace entertainment devices. Complete Home Theater systems, known as a Home Theater In a Box (HTIB), are available to consumers at reasonable prices. However, properly setting up such Home Theater systems can sometimes be problematic for the consumer.

Home theater systems provide a number of components, which may be located in various parts of the room. The components include the home theater receiver/amplifier, front stereo speakers (left and right), rear surround sound speakers (left and right), a center speaker, and a subwoofer. Various other combinations of speakers may also be used, including additional or fewer speakers. One such home theater system is described, for example, in U.S. Pat. No. 5,930,370, issued Jul. 27, 1999 to Ruzicka, incorporated herein by reference.

FIG. 4 depicts a diagrammatic view of the home theater surround sound speaker system (the surround sound system) 10 arranged in accordance with the principles of the present invention. The surround sound system 10 includes a source of a preferably amplified stereo signal, shown in FIG. 4 as television set 12. The stereo audio source may be any of a number of audio signal sources. It should, thus, be noted that the source of a stereo audio signal is represented herein as television 12, but the audio signal source may also be a stereo receiver, a car stereo, a portable compact disk or tape player, a portable boom-box type stereo, or any other source of a stereo signal.

Television 12 outputs an amplified audio signal to interconnect module 14 via a multi-conductor cable 16. Multi-conductor cable 16 typically includes two conductor pairs for conducting the left and right channels of the stereo signal output by television 12 to interconnect module 14. Interconnect module 14 receives the audio signals from television 12 and assembles the component left and right channel signals for selective distribution to particular component speakers of the surround sound system 10.

The component speakers typically include a sub-woofer 18, which receives full range left and right signals, but only reproduces the low frequency components of the audio signal. Interconnect module 14 also outputs an audio signal to front center speaker 20. Front center speaker 20 receives both the left and right component signals of the stereophonic signal and reproduces the (L+R) summation signal. Preferably, front center speaker 20 is located in proximity to television 12 and projects the acoustic output of the (L+R) summation signal toward the listener 28.

Interconnect module 14 also outputs the left channel signal to left satellite speaker 22 and right channel signal to right satellite speaker 24. Left satellite speaker 22 and right satellite speaker 24 may be relatively small speakers and need only reproduce mid range and/or high frequency signals. Left and right satellite speakers are preferably oriented so that the primary axis of radiation of the speaker points upward along a vertical axis; however, other orientations of the satellite speakers may also provide satisfactory performance. Interconnect module 14 also outputs an audio signal to rear ambience speaker 26. Rear ambience speaker 26 typically receives an audio signal in the form of a left channel minus right channel (L−R) or a right channel minus left channel (R−L) difference signal. As will become apparent throughout this detailed description, several embodiments of the invention described herein enable interconnect module 14 to generate a variety of signals to be output to left satellite speaker 22, right satellite speaker 24, and/or rear ambience speaker 26. It should be noted at the outset that the term speaker refers to a system for converting electrical input signals to acoustic output signals where the system may include one or a number of crossover networks and/or transducers.

The components described in FIG. 4 typically are arranged to optimize the surround sound effect to enhance the listening experience of the viewer 28. The viewer 28 typically faces television 12 which has front center speaker 20 arranged in proximity to television 12 so that center speaker 20 and television 12 radiate their respective audio and video output in the general direction of viewer 28. The left satellite speaker 22 typically is arranged to the left side of viewer 28 while right satellite speaker 24 is arranged to the right side of viewer 28, both satellite speakers typically being located nominally midway between the viewer 28 and television 12. Rear ambience speaker 26, which contributes to creating a spacious audio effect, is typically located behind viewer 28. Rear ambience speaker 26 is depicted as a single speaker, but multiple rear speakers 26 may be included in the system.

One problem with such systems is that a major aspect of acoustical sound reproduction may depend upon the relative location of each of the speakers in a room, relative to the preferred listening area, as well as room acoustics, speaker orientation, and the like. These aspects are largely outside the control of the manufacturer, as speaker placement can only be suggested by the manufacturer, and room configuration or other criteria may alter such placement by the consumer. In addition, the size of a room in which the system is setup is impossible to predetermine, and thus a great variance results in the placement, orientation, and location of speakers, as well as their relative distance from the preferred listening area and the receiver/amplifier.

One Prior Art approach for high-end home theater systems has been to hire a skilled acoustician to setup the home theater system. Such a skilled technician can adjust the location and placement of the speakers, and using various components, (adjustable delays, equalizers, and even passive acoustical components), optimize the sound quality for a particular room. Unfortunately, hiring an acoustician to fine tune a home theater system is expensive. Many “consumer grade” home theater systems sell for only a few hundred dollars, which is far less than the cost of even one in-home visit by an acoustician.

Another approach has been to provide a built-in system for measuring the relative time delay (e.g., location) of speakers within a room using a microphone and some processing equipment so that a consumer can calibrate the system for a given room. Such a system has many advantages, as it reduces the overall cost of installation, provides a better acoustical response to the system (resulting in fewer consumer complaints) and also allows the system to be easily moved to new locations.

While a number of such systems exist in the present market, one such system is illustrated, for example, by U.S. Pat. No. 6,655,212, issued on Dec. 2, 2003 to Ohta (hereafter “Ohta”), and incorporated herein by reference. FIG. 1 is a diagram from Ohta, illustrating a configuration of a measurement system including the sound field measuring apparatus. Measurement system 100 comprises a number of components. DSP (Digital Signal Processor) 1 outputs a test signal to D/A converters 2a, 2b, etc. Amplifiers 3a, 3b, etc. receive signals output from D/A converters 2a, 2b, etc. and drive speakers 4a, 4b, etc. Microphone 6 is disposed at a predetermined position (listening position) in an acoustic space 5 where the speakers 4a, 4b, etc. are placed. Amplifier 7 amplifies a signal output from microphone 6 and outputs the signal to A/D converter 8.

DSP 1 includes a number of components. Exponential pulse generator 11 generates an output signal to speaker (“SP”) selector 12, which in turn outputs the signal to a selected one (or more) of D/A converters 2a, 2b, etc. RAM 14 stores a received signal from A/D converter 8. Calculation section 15 uses the data stored in RAM 14 to calculate the time of arrival of an exponential pulse transmitted via speaker 4a, 4b, etc. Control section 13 operates exponential pulse generator 11 and RAM 14 so as to synchronize start timings. Calculation section 15 includes a rising emphasizing section 151, a time detecting section 152, and a calculating section 153.

Although not shown, DSP 1 has a signal processing circuit, which, during multi-channel audio reproduction using the speakers 4a, 4b, etc., delays each channel's signal by a predetermined time period. According to this configuration, the perceived distances between the speakers and the listening position can be made constant by adjusting the time delays to compensate for the actual differences in distance.

In operation, a system such as that illustrated in FIG. 1 may send a signal generated by exponential pulse generator 11 (or other sound source) to a speaker 3a, 3b, etc. via speaker selector 12. Microphone 6 maybe positioned by a consumer at a preferred listening location in the room. Microphone 6 receives the exponential pulse (or other sound) from speaker 3a, 3b, etc. and transmits this signal, via amplifier 7 and A/D converter 8 to RAM 14. Calculating section 15 may then measure the time delay between the output of the sound pulse from speaker 4a, 4b, etc. and the reception at microphone 6, and thus calculate the relative distance of the speaker from the preferred listening position. This value may be displayed to the user as a physical distance, and/or may be used as a time delay value internally. Each speaker 4a, 4b, etc. is tested in turn and relative time delays calculated. The home theater system can then adjust the relative time delays of each speaker accordingly to provide optimal sound levels at the preferred listening area.

Ohta employs what may be referred to as “Gated Noise”. The time of arrival is measured by using an impulse signal in the following manner. An impulse signal is output from a speaker. The signal is then detected by a microphone disposed at a predetermined position (listening position), and an impulse response between the speaker and the microphone (listener) is calculated. The time of arrival means a time period from a time when an impulse response is input, to that when an impulse response reaches the maximum peak value. This is basically a threshold-based technique that is very susceptible to errors from background noise (bad Signal-to-Noise Ratio (SNR)). For example, if a loud noise is made in the background during the setup, the system may interpret this sound as the peak value.

Another solution, known as Maximum Length Sequences (MLS), is described by Douglas D. Rife and John Vanderkooy, AES Vol. 37, No.6, 1989 June, “Transfer-Function Measurement with Maximum-Length Sequences”, incorporated herein by reference. The basic idea is to apply an analog version of an MLS to a linear system, sample the resulting response, and then cross-correlate that response with the original sequence. The result of the cross correlation is the system impulse response. Once the impulse response is obtained, the system delay is simply the location of the initial peak and the phase is the peak's polarity (in-phase: positive, out-of-phase: negative). Borish and Agell, “An Efficient Algorithm for Measuring the Impulse Response using Pseudorandom Noise”, J. Audio Eng. Soc., Vol. 31, No. 7, July/August 1983, incorporated herein by reference, also discloses how Maximum Length Sequences (MLS) can be used to measure the impulse response of a linear system.

This system may work well even with poor SNR, but it is limited to MLS noise as the source. Since the MLS sequence must be compared with the received response, it may be necessary to provide enough memory to store the entire MLS sequence for comparison purposes. The MLS signal may then be generated and a record of the signal stored in memory. The received signal may then be compared to this stored signal in order to determine the delay time and other acoustical characteristics of the speaker system. The memory and processing requirements can be prohibitive when measuring long distances. For example, a 1024-sample cross-correlation may be required to measure distances as large as 20 feet at a 48 kHz sampling frequency.

One seemingly minor problem with MLS techniques when used for audio calibration, is that the MLS signal, when played over a speaker system, produces an unpleasant audio sound which consumers may find annoying. When using an MLS signal to calibrate a home theater system, for example, a loud static-like noise may be produced from each speaker during the calibration process. Bystanders and even users may find this noise unpleasant and even uncomfortable. It would be advantageous to provide a system where more pleasing test signals could be used. It would also be desirable to provide a system whereby a characteristic signal could be used that may be indicative of manufacturer source (e.g., as a Trademark) or could produce musical or vocal renderings that could be pleasant to hear or even instructive (e.g., as part of the calibration process).

The general concept of Adaptive Filtering is known in the art. FIG. 2 is a block diagram illustrating the basic concepts of a single input, single output adaptive filter of the Prior Art. Adaptive Filtering is described in detail by Widrow and Stearns. “Adaptive Signal Processing” (1985, Prentice-Hall, Englewood Cliffs, N.J., ISBN 0-13-004029-0) incorporated herein by reference. The adaptive filtering system of FIG. 2 includes an input signal Xₖ 400 driving both the unknown plant 410 and the adaptive model 430. Output dₖ 460 from the unknown plant 420, is fed back and combined in subtractor 440 with the output Yₖ of the adaptive model to produce an error signal, which in turn adjusts the adaptive model 430 in a feedback loop.

In many practical cases, the unknown plant to be modeled 420 is noisy, that is, has internal random disturbing, forces. In FIG. 2, this noise is represented by plant noise 410 combined with the output of unknown plant 420 in adder 450. When the adaptive model 430 has enough flexibility to match the dynamic response of the unknown plant, its output will perfectly match that of the unknown plant 420 except for plant noise nₖ.

Internal plant noise 410 appears at plant output 460 and is commonly represented there as an additive noise. This noise is generally uncorrelated with the plant input 400. If adaptive model 430 is an adaptive linear combiner having weights adjusted to minimize mean-square error, the least-squares solution will be unaffected by the presence of the plant noise 410. The convergence of the adaptive process will be unaffected by plant noise 410, and the expected weight vector of the adaptive model 430 after convergence will be unaffected. The least-squares solution will be determined primarily by the impulse response of the plant to be modeled. The impulse response of the plant to be modeled may also be significantly affected by the statistical or spectral character of the plant input signal 400.

Thus, it remains a requirement in the art to provide a technique for measuring distance (delay) for a speaker whereby a noise source other than a MLS may be used to measure impulse response. It remains a further requirement in the art to provide a technique for measuring home theater system response while reducing memory requirements and/or increasing the available range of measurement for a given memory (MIPS) requirement.

### SUMMARY OF The INVENTION

The present invention uses a downsampled adaptive filter to find the impulse response. Downsampling yields higher maximum measurable distance for given filter length (e.g., down sample by two, and the maximum distance measurable doubles). By using a Least-Mean-Square (LMS) adaptive filter, almost anything can be used as the source noise. Downsampling does decrease the resolution of the distance measurement, but at 48 kHz downsampling by four changes, the resulting resolution may change, for example, from approximately 0.25 inch to approximately one inch, which for home theater calibration is not a significant change.

Maximum Length Sequence (MLS) and Adaptive Filtering are two separate techniques. In the preferred embodiment of the present invention, the particular form of Adaptive Filtering is a least-mean-square algorithm, or LMS. Adaptive Filtering allows a much broader range of test signals, as opposed to MLS where the test signal defines the technique (a pseudo-random Maximum Length Sequence.) With Adaptive Filtering, theoretically, almost any kind of test signal (music, speech, swept tones, noise, or the like), could be used. In one embodiment, a noise burst is used, but one that has a much more “pleasing” sound than the MLS techniques of the Prior Art.

The system of the present invention may perform two downsampling operations. Adaptive Filtering works by allowing a filter to change its coefficients based on the error between the test signal and the received signal, so both need to be at the same sample rate. The test signal sent to a speaker may be downsampled by a predetermined factor. This signal is also sent to the adaptive filter. A Digital to Analog Converter (DAC) converts the signal to analog form, which in turn drives the speaker.

A signal detector (e.g., microphone) receives the speaker signal, and an Analog to Digital Converter (ADC) converts the signal to digital form. The digital signal is also downsampled by the same predetermined factor and sent to the adaptive filter, so that both the input and output signals have the same sample rate.

A separate downsampling step may not be required if Digital to Analog Converters (DACs) and Analog to Digital Converters (ADCs) are available which support lower sampling rates (e.g., 48 kHz/4). However, since such DACs and ADCs are not widely available, the downsampling may be performed in a separate operation. In an alternative embodiment, downsampling may be applied similarly to a system using a MLS signal.

Adaptive filtering itself is known in the art and has been described previously with regard to FIG. 2. As noted above, adaptive filtering is a well-known concept in the digital filtering arts, and is basically a digital version of an analog feedback loop. Basically, the filter “adapts” to model the response of the “plant” (a system having unknown characteristics). From the adaptive model, it is possible to model the behavior of the system. However, it does not appear that the concept of the adaptive filter has been applied to the Home Theater calibration problem.

In the present invention, once the system is modeled with the adaptive filter, the characteristics of the system are known, and from this, system parameters, such a speaker placement in the room (here the “plant” being the speaker/room/home theater combination) can be determined. As illustrated in FIG. 2, an adaptive filtering system is relatively immune from background noise (in this application, people talking in the room, random noises, etc.). Thus, using an adaptive filter in this application results in a better measurement that is less susceptible to noise.

One additional bonus of using an adaptive filter for the home theater applications, is that the annoying MLS signals of the Prior Art, which sound like very loud static bursts, do not need to be used. In fact, almost any noise can be used from a soothing tone, to even a musical sound or verbal instruction.

A further aspect of the present invention is that by downsampling by 4, a better range of measurement is obtained. As noted above, for a 20 foot range (speaker distance from measuring point) a certain signal length may be required (to be stored and compared), which in turn requires a certain amount of memory.

By downsampling by four, the range is extended to 80 feet, which in the modern “mini-mansions” of today, is not an unheard of distance. The tradeoff is that the “granularity” or resolution of measurement goes from ¼ inch to 1 inch. However, since even minor movement of the user's head can exceed 1 inch, this tradeoff is considered well worthwhile.

### BRIEF DESCRIPTION OF THE DRAWINGS

FIG. 1 is a Prior Art diagram illustrating a configuration of a measurement system including a sound field measuring apparatus.

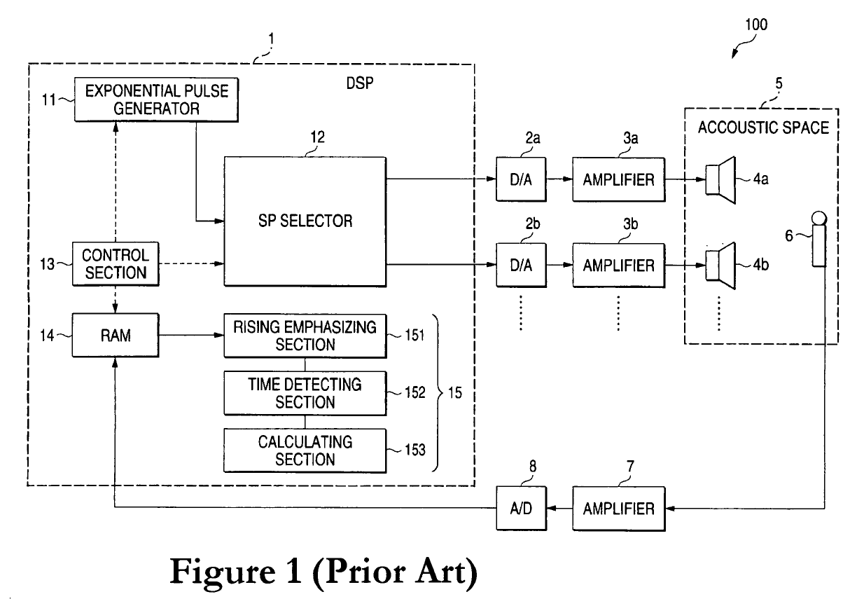

FIG. 2 is a block diagram illustrating the basic concepts of adaptive filtering in the Prior Art.

FIG. 3 is a block diagram of the apparatus of the present invention.

FIG. 4 is a block diagram of the home theater surround sound speaker system.

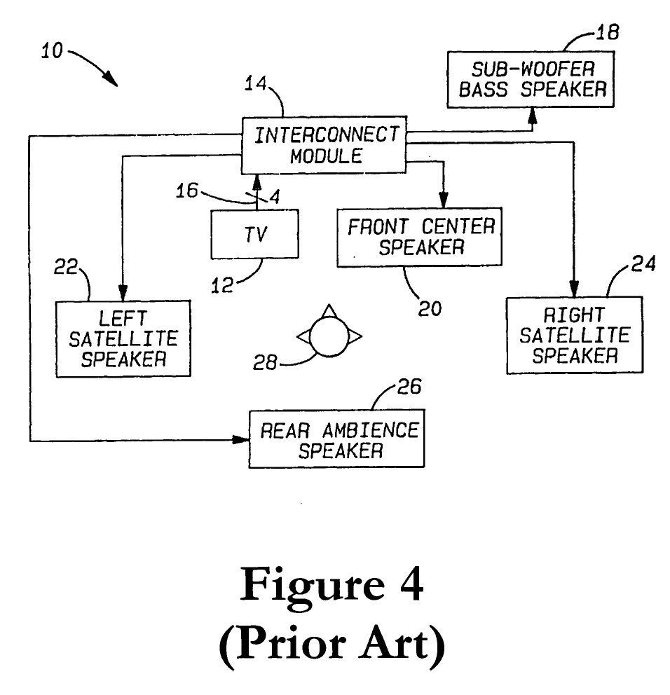

### DETAILED DESCRIPTION OF THE INVENTION

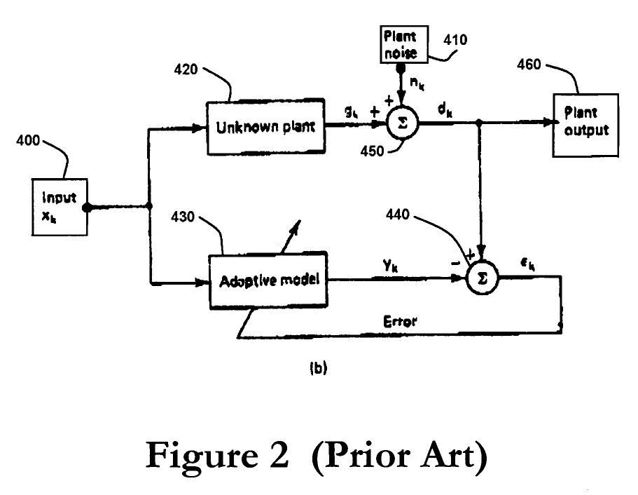

In the system of FIG. 2, the unknown plant refers to a general electrical system or circuit. The plant noise refers to any general intervening noise of such a plant. Applying the system of FIG. 2 to the problem of home theater calibration, the “unknown plant” 420 would, in this application, comprise the response of the room and speaker(s), and the “plant noise” 410 is any noise in the room (A/C, refrigerator, speech, and/or other background noise). The use of an adaptive filter for home theater calibration may make such calibration less sensitive to background interference and thus not require absolute quietness in the room for the consumer in order to perform the calibration.

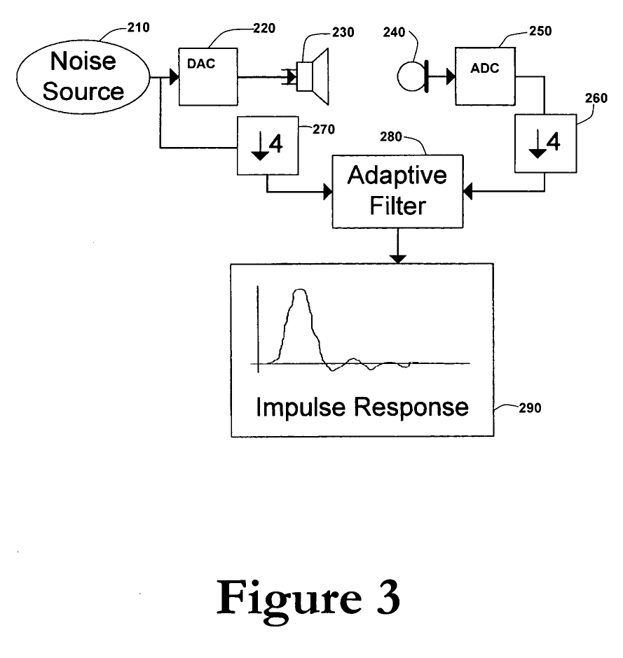

FIG. 3 is a block diagram of the apparatus of the present invention employing an adaptive filter for home theater calibration. For the sake of simplicity, many of the basic components in an auto-setup home theater system are not illustrated here. Referring to FIG. 3, a noise source 210 may be used to generate a sound pattern or series of impulses or the like. As discussed above, this sound source could comprise a number of sound patterns generated from a stored sound pattern or generated spontaneously. Since the choice of sound pattern is somewhat flexible (as opposed to MLS systems), a more pleasing sound to the consumer may be selected. A digital to analog converter (DAC) converts this digital sound pattern into an analog signal, which is then driven through speaker 220.

The digital signal from noise source 210 may also be downsampled (e.g., by a factor of 4) in downsampler 270, and the resultant signal sent as an input to adaptive filter 280. Downsampling, as discussed above, reduces the need to store large segments of data in adaptive filter 280 for signal comparison. To measure speaker distances between 0 and 20 feet may require 1024 or more digital samples to properly correlate the two signals (plant input and plant output) in order to effectively measure time delay, which in turns yields distance. The further apart the speakers are located, the more samples are generally required for comparison, as the correlation between the two responses may be further apart in time.

At a 48 KHz sampling frequency, as used in the Prior Art, this resultant granular resolution of speaker distance measurement is about one quarter inch, much more than is required for home theater calibration. A user can move their head several inches even while sitting in one place, so it makes no sense to provide for such fine granularity in distance measuring. The present invention sacrifices this unnecessary calibration accuracy for increased distance measurement capability, without increasing the memory (sample) requirements of the adaptive filter.

Thus, for example, by downsampling by a factor of four (4), the granularity may be increased to one inch (more than acceptable for home use) while the overall distance range is increased by a factor of four (e.g., to 80 feet), while using the same number of samples (1024). Given the cavernous nature of many new homes, such a distance range may be required for successful home theater calibration. Of course, other numbers of samples, granularities, downsampling rates, and distance ranges may be used within the spirit and scope of the present invention. The conversion from samples to distance is based on the speed of sound at sea level. Changes in altitude, temperature and humidity slightly affect the speed of sound, but only by hundredths of inches per sample at 48 kHz samplerate.

Referring again to FIG. 2, microphone 240 may be located by the consumer at a preferred listening location (e.g., near the head of the consumer at a favorite chair or the like). Microphone 240 picks up noise or other sound from speaker 230, which will be delayed by an amount of time equal to the speed of sound divided by the distance between microphone 240 and speaker 230. Other internal delays may, of course, exist within the electronics of the system, but such delays are minor and uniform and can be easily compensated for and are not affected by speaker location.

The output of microphone 240 may then be converted into a digital signal in analog to digital converter (ADC) 250. Output of ADC 250 is downsampled by the same factor as downsampler 270 (e.g., 4) and the output fed as the plant output to adaptive filter 280. The output of adaptive filter 280 generates an impulse response 290, which in turn provides a value indicative of the distance between speaker 230 and microphone 240.

In co-pending application Ser. No. 11/002,102, incorporated herein by reference, and from which the present application claims priority, calculation of speaker distance may be achieved by measuring the location of the impulse response peak as well as from the width of this peak at a given level, or by combining these two values using a polynomial equation, lookup table, or the like.

With the apparatus of the present invention, almost any sound could be used as a noise source. Thus, a characteristic pleasing sound may be used, which may also be indicative of a product or system source, much as the THX sound is used in movie theaters to inform audience members of the sound system type. Alternately, a voice instruction may be used to help the consumer understand the process (e.g., “now calibrating, left speaker”). Similarly, a consumer provided sound source (e.g., CD or the like) may be used such that the system can be calibrated without having to interrupt the playback of a CD, DVD, or other audio source. By pressing a button on a remote, the system could calibrate each speaker (selectively) without having to interrupt the audio being played at the time.

In an alternative embodiment, once the impulse response of the system has been measured (either directly, or by MLS or LMS), mathematical operations can be performed on the impulse response data using, e.g., a Fast Fourier Transform (FFT) to obtain the magnitude and phase response of the system (room plus speaker). Many Prior Art systems using MLS already do this; however, the low-frequency resolution of the resultant response is not favorable. The impulse response from LMS may also be converted to obtain the magnitude and phase response in a similar manner to Prior Art MLS systems. Downsampling, however, reduces the frequency range of the response. Thus, in such an embodiment, downsampling may be reduced or eliminated to limit this reduction.

The term “phase” may be used in two slightly different ways. First, the “phase of the speaker” is used to refer to the polarity, that is, which way the two wires are connected. This version of “phase” may take one of two values, either “in-phase” or “out-of-phase”. Second, the “phase response” of the speaker in the room is a function of frequency, like the power spectrum. The power spectrum, or magnitude response (often inaccurately just called the “frequency response”) is the power level (Y-axis, usually in dB) plotted against frequency (X-axis in Hz). The phase response is also a function of frequency.

Also, the magnitude and phase responses are really two halves of the overall “Response” of the system. Sometimes this term “Response” may be referred to by the phrase “the magnitude and phase response”, which is singular term instead of a plural term, as the response that contains both magnitude and phase information before they are separated into two responses. In some instances, the term “frequency response” may be used to indicate the total response (magnitude and phase).

In the present invention, downsampling actually helps in finding the phase (polarity) of the speaker (the first definition of “phase” noted above). However, if one wanted to know the complete magnitude and phase response of the speaker, (the second definition of “phase” noted above) downsampling may reduce the upper ¾ of the response. Thus, for this type of Phase response measurement, it may be advisable to reduce or eliminate downsampling.

While the preferred embodiment and various alternative embodiments of the invention have been disclosed and described in detail herein, it may be apparent to those skilled in the art that various changes in form and detail may be made therein without departing from the spirit and scope thereof.

I claim:

1. A method for measuring distance of a speaker from a selected location, comprising:
generating a digital audio test signal,
receiving an audio test signal output from a speaker to a signal detector placed at a selected location,
converting the audio signal at the signal detector to a received digital audio signal;
filtering, using an adaptive filter, the digital audio signal and the received digital audio signal to detect a time delay between the downsampled digital audio signals, and
calculating a distance from the speaker to the selected location from the time delay.

2. The method of claim 1, further comprising:
converting the digital audio test signal to an analog audio signal, and
outputting the analog audio signal from the speaker.

3. The method of claim 2, wherein the signal detector comprises a microphone placed at the predetermined location.

4. The method of claim 1, further comprising:
downsampling both the digital audio signal and the received digital audio signal by a predetermined downsampling factor prior to filtering.

5. The method of claim 4, wherein downsampling comprises downsampling by a factor of 4.

6. The method of claim 1, wherein generating a digital audio test signal comprises generating a predetermined audio signal pattern including a noise burst from the speaker.

7. The method of claim 4, further comprising the steps of:
adjusting a time delay of the speaker to correct for the distance from the speaker to the selected location.

8. An apparatus for measuring distance of a speaker from a selected location, comprising:
a digital audio signal source,
an audio output for receiving the digital audio signal and providing an audio signal output from a speaker,
an audio input for receiving an audio signal from a microphone placed at the selected location and outputting a received digital audio signal,
an adaptive filter for filtering the digital audio signal and the received digital audio signal to detect a time delay between the downsampled digital audio signals, and
a processor for calculating a distance from the speaker to the selected location from the time delay.

9. The apparatus of claim 8, further comprising:
a downsampler for downsampling both the digital audio signal and the received digital audio signal by a predetermined downsampling factor prior to filtering.

10. The apparatus of claim 9, wherein the downsampler comprises a downsampler having a downsampling factor of 4.

11. The apparatus of claim 9, wherein the downsampler comprises a first downsampler for downsampling the digital audio signal, and a second downsampler for downsampling the received digital audio signal.

12. The apparatus of claim 8, wherein the digital audio source comprises a predetermined audio signal pattern including a noise burst.

13. A home theater system provided with an auto-setup mode for measuring distance of a speaker from a selected listening location and delaying audio signals to the speaker proportionally to the distance of the speaker from the selected location, the home theater system, comprising:
at least one speaker output for generating an audio signal from a speaker,
a microphone input, for receiving the audio signal when a microphone is placed at the selected listening location,
an adaptive filter for filtering the audio signal and the received audio signal to detect a time delay between the downsampled digital audio signals, and
a processor for calculating a distance from the speaker to the selected location from the time delay and adjusting a time delay for audio signal generated by the at least one speaker.

14. The home theater system of claim 13, further comprising:
a digital signal source for generating a digital audio test signal,
a digital to analog converter for converting the digital audio test signal to an analog audio signal for output from the at least one speaker output, and
an analog to digital converter, coupled to the microphone input, for converting a received audio signal at the microphone to a received digital audio signal.

15. The home theater system of claim 14, further comprising:
a downsampler for downsampling both the digital audio signal and the received digital audio signal by a predetermined downsampling factor prior to filtering.

16. The home theater system of claim 15, wherein the downsampler comprises a downsampler having a downsampling factor of 4.

17. A method of calibrating a home theater system provided with an auto-setup mode for measuring distance of a speaker from a selected listening location and delaying audio signals to the speaker proportionally to the distance of the speaker from the selected location, the method of calibrating a home theater system comprising:
generating, from at least one speaker output, an audio signal from a speaker,
receiving, from a microphone input, the audio signal when a microphone is placed at the selected listening location,
filtering, using an adaptive filter, the audio signal and the received audio signal to detect a time delay between the downsampled digital audio signals, and
calculating a distance from the speaker to the selected location from the time delay and adjusting a time delay for audio signal generated by the at least one speaker.

18. The method of calibrating a home theater system of claim 17, further comprising:
generating the digital audio test signal from a digital signal source,
converting, in a digital to analog converter, the digital audio test signal to an analog audio signal for output from the at least one speaker output, and
converting in an analog to digital converter coupled to the microphone input, a received audio signal at the microphone to a received digital audio signal.

19. The method of calibrating a home theater system of claim 18, further comprising:
downsampling both the digital audio signal and the received digital audio signal by a predetermined downsampling factor prior to filtering.

20. The method of calibrating a home theater system of claim 19, wherein downsampling comprises downsampling by factor of 4.

17. The home theater system of claim 16, wherein the downsampler comprises a first downsampler for downsampling the digital audio signal, and a second downsampler for downsampling the received digital audio signal.

18. The home theater system of claim 14, wherein the digital signal source comprises a predetermined audio signal pattern including a noise burst.
